(19) United States
(12) Patent Application Publication
(10) Pub. No.: US 2026/0209460 A1
(43) Pub. Date: Jul. 23, 2026

(54) METHOD FOR REMOVAL OF PLASTICIZER FROM A POLYMERIC MATERIAL

(71) Applicant: BASE SE, Ludwigshafen am Rhein (DE)

(72) Inventors: Sina WITZEL, Ludwigshafen am Rhein (DE); Christian REIN, Ludwigshafen am Rhein (DE); Axel GRIMM, Ludwigshafen am Rhein (DE); Matthias PFEIFFER, Ludwigshafen am Rhein (DE); Rainer PAPP, Ludwigshafen am Rhein (DE); Herbert MORGENSTERN, Ludwigshafen am Rhein (DE)

(21) Appl. No.: 19/141,299

(22) PCT Filed: Dec. 20, 2023
(86) PCT No.: PCT/EP2023/086850

§ 371 Date: Jun. 19, 2025

(30) Foreign Application Priority Data
Dec. 21, 2022 (EP) 22215278.7

(51) Int. Cl. C08J 11/02; C08J 11/08; C08K 5/00

(52) U.S. Cl. CPC C08J 11/02; C08J 11/08; C08K 5/0016

(57) ABSTRACT

A first aspect of the invention is directed to a method for removal of plasticizer from a polymeric material comprising: (a) providing a polymeric material, which comprises a polymer and a plasticizer, and providing a solvent comprising gamma-valerolactone; and (b) contacting the polymeric material with the solvent comprising gamma-valerolactone, thereby obtaining a liquid mixture, which comprises the solvent, dissolved polymer and dissolved plasticizer. In a second aspect, the invention relates to a polymer obtained or obtainable from the method according to the first aspect. A third aspect of the invention is directed to a plasticizer obtained or obtainable from the method according to the first aspect. In a fourth aspect, the invention relates to the use of the polymer obtained or obtainable from the method according to the first aspect preparing a polymeric product, wherein a fifth aspect of the invention is directed to the use of the plasticizer obtained or obtainable from the method according to the first aspect for preparing a soft polymer. A sixth aspect of the invention relates to a process for further processing of a plasticizer, the process comprising one or more work-up steps selected from the group consisting of hydrolysis, hydrogenation, and transesterification.

A first aspect of the invention is directed to a method for removal of plasticizer from a polymeric material comprising: (a) providing a polymeric material, which comprises a polymer and a plasticizer, and providing a solvent comprising gamma-valerolactone; and (b) contacting the polymeric material with the solvent comprising gamma-valerolactone, thereby obtaining a liquid mixture, which comprises the solvent, dissolved polymer and dissolved plasticizer. In a second aspect, the invention relates to a polymer obtained or obtainable from the method according to the first aspect. A third aspect of the invention is directed to a plasticizer obtained or obtainable form the method according to the first aspect. In a fourth aspect, the invention relates to the use of the polymer obtained or obtainable from the method according to the first aspect preparing a polymeric product, wherein a fifth aspect of the invention is directed to the use of the plasticizer obtained or obtainable from the method according to the first aspect for preparing a soft polymer. A sixth aspect of the invention relates to a process for further processing of a plasticizer, the process comprising one or more steps selected from the group consisting of hydrolysis, hydrogenation, and transesterification.

Synthetic polymers are commonly used in two different forms, i.e. in rigid form or in flexible, so called soft form. Softening is normally achieved by the addition of plasticizers to the polymeric materials, the most widely used being phthalates. In view of the increasing use of polymeric materials, also the need for recycling of polymeric materials has arisen in view of saving of raw materials as well as in view of reduction of plastic waste. However, for recycling, there is also a need to separate the polymeric materials from the incorporated plasticizers, especially in view of the fact that several plasticizers are toxic or are connected with other environmental or health related issues, especially since it is sometimes intended to use the recycled polymeric materials in a different area of application—for example, a polymer used for a window profile shall be reused for a toy. Thus, recycling is in most cases only possible after extraction of plasticizers, wherein a mild method for separation of polymeric material and plasticizers would be highly desirable. “Mild” preferably meaning that first, harmless chemicals are used and second, that the polymer(s) and/or the plasticizer(s) are recovered undamaged. However, so far, the methods known in the art use fossil-based chemicals, which are at least partly toxic and the processes for plasticizer extraction are complicated and required complex solvent systems. For example, WO 01/70865 A1 discloses a process for recycling a plastic material, wherein the plastic material may be a polar polymer such as a polymer of vinyl chloride (PVC). The process includes dissolution of the plastic material, wherein a solvent is used having a solubility parameter, which is close to the solubility parameter of the plastic to be dissolved; only methyl ethyl ketone (MEK) is given as suitable solvent. Water is used for precipitation of the dissolved plastic material.

Aside from being flammable and moderately explosive, MEK has also health related issues as it can, for example, cause serious eye irritation. WO 02/14413 A1 discloses a process for separating and recovering target polymers and their additives from a material containing polymers, wherein the target polymer and at least one additive are dissolved in a solvent, the dissolved target polymer with the additives is mixed with anon-aqueous solvent II (precipitating agent), which is miscible with the solvent I, in such a manner that the target polymer is precipitated. Solvent I is selected from the group of low molecular alcohols (C1-C5), cyclic ethers (e.g. tetrahydrofurane), aliphatic ketones (e.g. acetone, methylethylketone), cyclic ketones (e.g. cyclohexanon), dibasic ester mixtures (e.g. DBE-mixtures of dimethyl esters of dicarboxylic acids such as glutaric acid, succinic acid and adipic acid) and mixtures of these solvents, the solvent II is a low molecular alcohol (C1-C5). Also here, the solvents used for dissolution of the polymer are dangerous and connected to several health issues, as indicated, for example, for MEK above. U.S. Pat. No. 4,071,479 A relates to a process for recovering a reusable essentially pure vinyl chloride polymer resin from a polymer mixture including dissolution of the vinyl chloride polymers and subsequently use of a non-solvent which is miscible with the solvent in substantially all proportions to precipitate an essentially pure vinyl chloride polymer resin. The solvents indicated for dissolution of the polymer are methyl ethyl ketone, tetrahydrofuran, and dimethyl formamide, the anti-solvent being selectable from methanol, isopropanol, n-butanol, or an azeotrope of methyl ethyl ketone and methanol. Also here, the solvents used for dissolution of the polymer are dangerous and connected to several health issues, as indicated, for example, for MEK above.

The object underlying the present invention was thus the provision of an improved process, which enables a simple extraction of one or more plasticizer(s) from a polymeric material while avoiding or at least reducing the use of hazardous solvent(s) and which enables to recover the polymer(s) and/or the plasticizer(s) undamaged.

### 1^{st} Aspect—Method for Removal of Plasticizer

In a first aspect, the problem was solved by the provision of a method for removal of plasticizer from a polymeric material, the method comprising:
(a) providing a polymeric material, which comprises a polymer and a plasticizer, and providing a solvent comprising gamma-valerolactone;
(b) contacting the polymeric material with the solvent comprising gamma-valerolactone, thereby obtaining a liquid mixture, which comprises the solvent, dissolved polymer and dissolved plasticizer.

Gamma-valerolactone (C₅H₈O₂; IUPAC: 5-methyloxolan-2-one, abbreviation: GVL) is obtainable from carbohydrate-based biomasses, for example, it is readily obtained from sugar, and is thus a “green” solvent. It had so far only been described at the outmost as being able to dissolve polymeric materials. The GVL used in the context of the present invention is preferably a biorenewable solvent (biorenewable GVL), preferably GVL tested to comprise biobased carbon according to ASTM Standard D6866-16. It has now been surprisingly found that, especially for polymeric materials comprising one or more polymer(s) as described below, especially for polymeric materials comprising polyvinylchloride (PVC, TP.30 below), gamma-valerolactone enables a removal of plasticizer from the polymeric material without detrimental effects on the polymeric material, i.e. the polymeric material obtained, which is depleted in plasticizer compared to the polymeric material provided in (a), has at least the same number average molecular weight Mn and has about the same mass average molecular weight Mw as the polymeric material provided in (a). That is, using GVL enables to recover the polymer(s) in undamaged form. Furthermore, it was surprisingly found that GVL is superior compared to other solvents regarding plasticizer removal from the polymeric material in that it removes significantly more plasticizer from the polymeric material than other solvents.

In some preferred embodiments of the method for removal of plasticizer from a polymeric material, the method further comprises:
(c) precipitating the polymer from the mixture obtained in (b) by addition of an anti-solvent, thereby obtaining a solid residue, which comprises the polymer, and a liquid phase, which comprises the solvent, the anti-solvent and the dissolved plasticizer.

In some preferred embodiments of the method for removal of plasticizer from a polymeric material, the polymer is preferably a thermoplastic polymer selected from the group consisting of
thermoplastic copolymer, which comprises in polymerized form at least two different monomers, the monomers being selected from the group consisting of C₂ to C₁₀ mono olefin (preferably selected from the group consisting of ethylene, propylene, 1,3-butadiene, 2-chloro-1,3-butadiene and mixtures of two or more of these olefins), vinylalcohol, C₂ to C₁₀-alkylester of vinylalcohol, vinylacetate, vinylchloride, vinylidene chloride, vinylidene fluoride, tetrafluoroethylene, glycidyl acrylate, glycidyl methacrylate, acrylate with alcohol component of branched or unbranched C1 to C10 alcohol methacrylate with alcohol components of branched or unbranched C1 to C10 alcohol, vinyl aromatic (preferably styrene), (meth)acrylonitrile, ethylenically unsaturated mono- or dicarboxylic acid, and maleic anhydride (TP.1);
polyvinyl ester (TP.2);
polycarbonate (TP.3);
polyether (TP.4);
polyether ketone (TP.5);
thermoplastic polyurethane (TP.6);
polysulfide (TP.7);
polysulfone (TP.8);
polyester (TP.9);
polyalkylene terephthalate (TP.10);
polyhydroxyalkanoate (TP.11);
polybutylene succinate (TP.12);
polybutylene succinate adipate (TP.13);
polyacrylate with the same or different alcohol residues from the group of C4 to C8 alcohols, preferably selected from butanol, hexanol, octanol, and 2-ethylhexanol (TP.14);
polymethyl methacrylate (TP.15);
methyl methacrylate-butyl acrylate copolymer (TP.16);
acrylonitrile-butadiene-styrene copolymer (TP.17);
ethylene-propylene copolymer (TP.18);
ethylene-propylene-diene copolymer (TP.19);
polystyrene (TP.20);
styrene-acrylonitrile copolymer (TP.21);
acrylonitrile-styrene acrylate (TP.22);
styrene-butadiene-methyl methacrylate copolymer (TP.23);
styrene-maleic anhydride copolymer (TP.24);
styrene-methacrylic acid copolymer (TP.25);
polyoxymethylene (TP.26);
polyvinyl alcohol (TP.27);
polyvinyl acetate (TP.28);
polyvinyl butyral (TP.29);
polyvinyl chloride (TP.30);
polycaprolactone (TP.31);
polyhydroxybutyric acid (TP.32);
polyhydroxyvaleric acid (TP.33);
polylactic acid (TP.34);
ethyl cellulose (TP.35);
cellulose acetate (TP.36);
cellulose propionate (TP.37);
cellulose acetate/butyrate (TP.38)
   and blends of two or more of these polymers.

In some preferred embodiments, polyethylene terephthalate (PET) is excluded from the list of polymers of TP.1 to TP.38, in some further preferred embodiments, the polymer is preferably a thermoplastic polymer selected from the group consisting of TP.1 to TP.9 and TP.11 to TP.38 and blends of two or more of these polymers. In some preferred embodiments, the polymer is preferably a thermoplastic polymer selected from the group consisting of TP.1 to TP.8 and TP.11 to TP.38 and blends of two or more of these polymers.

In some preferred embodiments of the method for removal of plasticizer from a polymeric material, the polymer is selected from the group consisting of copolymer comprising in polymerized form vinylchloride and at least one further monomer selected from the group indicated in embodiment 3 for TP.1 (TP.1.1); polyvinyl acetate (TP.28); polyvinyl butyral (TP.29); polyvinyl chloride (TP.30); polycaprolactone (TP.31); and blends of two or more of these polymers.

In some preferred embodiments of the method for removal of plasticizer from a polymeric material, the polymer comprises polyvinyl chloride (TP.30), wherein preferably at least 90 weight-%, more preferably at least 95 weight-%, more preferably at least 98 weight-%, of the polymer comprised in the polymeric material are polyvinyl chloride, based on the overall weight of the polymer comprised in the polymeric material being 100 weight-%.

In some preferred embodiments of the method for removal of plasticizer from a polymeric material, at least 20 weight-% of the polymeric material consists of the polymer, more preferably in the range of from 20 to 90 weight-% of the polymeric material consist of the polymer, the overall weight of the polymeric material being 100 weight-%.

In general, polyvinyl chloride is obtained by homopolymerization of vinyl chloride. The polyvinyl chloride is prepared, for example, by (micro) suspension polymerization or bulk polymerization. The production of polyvinyl chloride by polymerization of vinyl chloride and the production and composition of plasticized polyvinyl chloride are described, for example, in “Becker/Braun, Kunststoff-Handbuch, Band 2/1: Polyvinylchlorid”, 2nd edition, Carl Hanser Verlag, Munich.

In some preferred embodiments, the polymeric material is a soft PVC, which preferably has a shore rigidness in the range of from 35 shore A to 70 Shore D, determined according to DIN 53505:2000-08.

In some embodiments, the polymeric material comprises the plasticizer distributed in the polymer or in alternative embodiments, the polymer, preferably in powdered form, is dispersed, optionally with pigments, fillers and additives, such as blowing agents, in a liquid plasticizer (plastisol). The plasticizer is not chemically bonded to the polymer but rather embedded in the polymer or the polymer is dispersed in the (liquid) plasticizer.

In some preferred embodiments of the method for removal of plasticizer from a polymeric material, the solvent comprising gamma-valerolactone comprises gamma-valerolactone and optionally one or more solvent(s) selected from the group consisting of water and organic solvents having a log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O—]ₙ—H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R¹R²N—C(═O)—R³, wherein R¹, R² are independently a C1 to C4 alkyl group and R³ is selected from the group consisting of C1 to C9 alkyl group, C1 to C10 ester group and C1 to C6 ether group, C3 to C6 lactame, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).

Preferably at least 1 weight-%, more preferably at least 5 weight-%, more preferably at least 10 weight-%, more preferably at least 20 weight-%, more preferably at least 30 weight-%, more preferably at least 40 weight-%, more preferably at least 50 weight-%, more preferably at least 60 weight-%, more preferably at least 70 weight-%, more preferably at least 80 weight-%, more preferably at least 90 weight-%, more preferably at least 95 weight-%, more preferably at least 95 weight-%, more preferably at least 96 weight-%, more preferably at least 97 weight-%, more preferably at least 98 weight-%, more preferably at least 99 weight-%, of the solvent consists of gamma-valerolactone based on the total weight of the solvent being 100 weight-%.

Suitable solvents are known to the skilled person, as well as the decadic logarithm of the octanol-water partition coefficient (log K_{OW}). The octanol-water partition coefficient K_{OW} of a given compound is defined as the ratio of said compound's chemical concentration in the octanol phase relative to said compound's chemical concentration in the aqueous phase in a two-phase system of 1-octanol and water at a temperature of 25° C. (298 K). Methods to determine the octanol-water partition coefficient K_{OW} of a given compound are known to the skilled person. For example, the octanol-water partition coefficient K_{OW} of a given compound is determined using the shake-flask method which consists of dissolving the compound in a volume of high-purity 1-octanol and deionized water (pre-mixed and calibrated for at least 24 h) and measuring the concentration of the compound in each the 1-octanol phase and the water phase by a sufficiently exact method, preferably via UV/VIS spectroscopy. This method is described in the OECD Guideline for the testing of chemicals, number 107, adopted on Jul. 27, 1995. Values of K_{OW} for a plurality of substances are known and are easy to be found, for example, in the Dortmund Database (DDB, cf. http://www.ddbst.com/ddb-search).

Regarding suitable solvents, for example, an aliphatic C1 to C10 alcohol is preferably a C1 to C6 monool, more preferably one or more selected from the group consisting of methanol, ethanol and butanol. A C3 to C10 ketone is preferably acetone or methylethyl ketone or a mixture of acetone and methylethyl ketone. A C2 to C10 cyclic ketone is preferably cyclohexanone. A C3 to C10 cyclic ether optionally substituted with one or more C1 to C3 alkyl group(s) is preferably tetrahydrofuran or 2-methyltetrahydrofuran or a mixture of tetrahydrofuran and 2-methyltetrahydrofuran. A C6 to C10 aromatic hydrocarbon, optionally substituted with one or more C1 to C3 alkyl group(s) is preferably one or more selected from the group consisting of benzene, toluene, ethylbenzene, xylene (o or p) and mesitylene. A C1 to C10 ester is preferably one or more selected from the group consisting of esters of a C1 to C6 aliphatic monol with a C2 to C5 aliphatic acid. A C5 to C10 cyclic carboxylic ester (lactone) is preferably one or more selected from the group consisting of delta-valerolactone, methylated γ-butyrolactone, ethylated γ-butyrolactone, propylated γ-butyrolactone, and β-propiolactone. A C3 to C6 lactame, optionally substituted with one or more C1 to C3 alkyl group(s), is preferably selected from the group consisting of 2-pyrrolidone, 3-pyrrolidone and mixtures of 2-pyrrolidone, 3-pyrrolidone, each optionally substituted with one or more C1 to C3 alkyl group(s), preferably at the nitrogen atom, more preferably N-methyl-2-pyrollidone. An imidazolidone, optionally substituted with one or more C1 to C3 alkyl group(s) is preferably 1,3-dimethyl-2-imidazolidinone.

In some preferred embodiments of the method for removal of plasticizer from a polymeric material, the plasticizer is selected from the group consisting of
cyclohexane-1,2-dicarboxylic acid dialkylester, wherein the alkyl groups are independently selected from C4-C13 alkyl;
cyclohexane-1,3-dicarboxylic acid dialkylester, wherein the alkyl groups are independently selected from C4-C13 alkyl;
cyclohexane-1,4-dicarboxylic acid dialkylester, wherein the alkyl groups are independently selected from C4-C13 alkyl;
phthalic acid dialkylester wherein the alkyl groups are independently selected from C4-C13 alkyl;
phthalic acid alkylarylester wherein the alkyl group is selected from C4-C13 alkyl and the aryl group is selected from benzyl and phenyl;
terephthalic acid dialkylester wherein the alkyl groups are independently selected from C4-C13 alkyl;
trimellitic acid trialkylester;
benzoic acid alkylester;
dibenzoic acid esters of glycols;
pentaerythritol esters;
saturated monocarboxylic acid alkylester;
unsaturated monocarboxylic acid ester;
saturated dicarboxylic acid diester;
unsaturated dicarboxylic acid diester;
aromatic sulfonic acid ester;
alkylsulfonic acid ester;
glycerol ester;
isosorbide ester;
phosphoric acid ester;
citric acid triester;
acetylated citric acid triester;
alkylpyrrolidone derivative;
2,5-furane dicarboxylic acid dialkylester;
2,5-tetrahydrofurane dicarboxylic acid dialkylester;
polyester of aliphatic and/or aromatic polycarboxylic acid with at least dialcohol(s);
epoxidized plant oil;
epoxidized fatty acid mono alkyl ester;
   and mixture of two or more thereof.

A cyclohexane-1,2-dicarboxylic acid dialkyl ester has in the range of from 4 to 14 C atoms in the alkyl chain(s). The alkyl chains of the cyclohexane-1,2-dicarboxylic acid dialkyl ester independently of each other have the same or a different number of C atoms. A cyclohexane-1,2-dicarboxylic acid dialkyl ester is preferably selected from the group consisting of di-(2-ethylhexyl)-1,2-cyclohexane dicarboxylate, di-(isononyl)-1,2-cyclohexanedicarboxylate, or di-(2-propylheptyl)-1,2-cyclohexane dicarboxylate and mixtures of two or more thereof. A cyclohexane-1,3-dicarboxylic acid dialkyl ester has in the range of from 4 to 14 C atoms in the alkyl chain(s). The alkyl chains of the cyclohexane-1,3-dicarboxylic acid dialkyl ester independently of each other have the same or a different number of C atoms. A cyclohexane-1,4-dicarboxylic acid dialkyl ester has 4 to 13 C atoms in the alkyl chains. The alkyl chains of the cyclohexane-1,4-dicarboxylic acid dialkyl ester independently of each other have the same or a different number of C atoms. A cyclohexane-1,4-dicarboxylic acid dialkyl ester is preferably selected from the group consisting of di-(2-ethylhexyl)cyclohexane-1,4-dicarboxylate, di-(isononyl)-1,4-cyclohexanedicarboxylate, or di-(2-propylheptyl)-1,4-cyclohexanedicarboxylate and mixtures of two or more thereof. A phthalic acid dialkyl ester has 4 to 13 C atoms in the alkyl chains. The alkyl chains independently of each other have the same or different numbers of C atoms. A phthalic acid dialkyl ester may be di-isononyl phthalate. A terephthalic acid dialkyl ester has 4 to 13 C atoms in the alkyl chains. The alkyl chains independently of each other have the same or different numbers of C atoms. A trimellitic acid trialkyl ester has 4 to 13 C atoms in the alkyl chains. The alkyl chains of the trimellitic acid trialkyl ester independently of each other have the same or a different number of C atoms. A benzoic acid alkyl ester has 7 to 13 C atoms in the alkyl chain.

A benzoic acid alkyl ester is preferably selected from the group consisting of isononyl benzoate, isodecyl benzoate, 2-propylheptyl benzoate and mixtures of two or more thereof. A dibenzoic acid ester is preferably selected from the group consisting of diethylene glycol dibenzoate, dipropylene glycol dibenzoate, tripropylene glycol dibenzoate, dibutylene glycol dibenzoate and mixtures of two or more thereof. A saturated monocarboxylic acid ester is preferably selected from the group consisting of an ester of acetic acid, an ester of butyric acid, an ester of valeric acid, an ester of lactic acid and mixtures of two or more thereof. A saturated monocarboxylic acid ester is in alternative embodiments preferably selected from the group consisting of ester of a monocarboxylic acid with a polyhydric alcohol. For example, valeric acid may be esterified with pentaerythritol. An unsaturated monocarboxylic acid ester is preferably an ester of acrylic acid. An unsaturated dicarboxylic acid diester is preferably an ester of maleic acid. An alkyl sulfonic acid ester has 8 to 22 C atoms in the alkyl chain. An alkyl sulfonic acid ester is preferably a phenyl or cresyl ester of pentadecyl-sulfonic acid. An isosorbide ester is usually an isosorbide diester esterified with C8 to C13 carboxylic acids. An isosorbide diester has different or identical C8 to C13 alkyl chains. A phosphoric acid ester is preferably selected from the group consisting of tri-2-ethylhexyl phosphate, trioctyl phosphate, triphenyl phosphate, isodecyl diphenyl phosphate, bis-2 (2-ethylhexyl) phenyl phosphate, 2-ethylhexyldiphenyl phosphate, and mixtures of two or more thereof. In a citric acid triester, the OH group is free or in carboxylated form, for example acetylated form. The alkyl chains of the citric acid triester or the acetylated citric acid triester independently comprise 4 to 8 C atoms. An alkylpyrrolidone derivative has 4 to 18 C atoms in the alkyl chain. A 2,5-furandicarboxylic acid dialkyl ester has 5 to 13 C atoms in the alkyl chains. The alkyl chains of the 2,5-furanedicarboxylic acid dialkyl ester independently have different numbers of C atoms. A 2,5-tetrahydrofuranedicarboxylic acid dialkyl ester has 5 to 13 C atoms in the alkyl chains. The alkyl chains of the 2,5-tetrahydrofuranedicarboxylic acid dialkyl ester independently have a different number of C atoms. A polyester with aromatic or aliphatic polycarboxylic acids is preferably a polyester based on adipic acid with polyhydric alcohols, such as dialkylene glycol polyadipates with 2 to 6 C atoms in the alkylene unit. Examples may include polyester adipates, polyglycol adipates and polyester phthalates.

In some preferred embodiments of the method for removal of plasticizer from a polymeric material, the plasticizer comprises at least a cyclohexane-1,2-dicarboxylic acid dialkylester of formula (I)

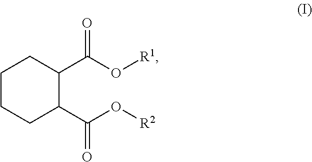

wherein R¹ and R² are independently selected from the group of branched C4 to C13 alkyl and straight C1 to C13 alkyl, preferably selected from the group consisting of branched C7 to C11 alkyl and straight C7 to C11 alkyl, more preferably R¹ and R² are independently from each other a branched or straight C9 alkyl residue, more preferably the plasticizer comprises at least 1,2-cyclohexane dicarboxylic acid diisononyl ester (DINCH).

In some preferred embodiments of the method for removal of plasticizer from a polymeric material, the polymeric material comprises the plasticizer in an amount in the range of from 20 to 490 phr. “phr” means “parts per hundred” and indicates the amount of plasticizer per 100 parts of polymeric material.

In some specific embodiments, the polymer comprised in the polymeric material provided in (a) comprises at least polyvinyl chloride (TP.30) and the plasticizer comprised in the polymeric material provided in (a) comprises at least DINCH. In these specific embodiments, the method for removal of plasticizer from a polymeric material comprises:
(a) providing a polymeric material, which comprises at least polyvinyl chloride (TP.30) as polymer and a plasticizer, which comprises at least DINCH, and providing a solvent comprising gamma-valerolactone;
(b) contacting the polymeric material with the solvent comprising gamma-valerolactone, thereby obtaining a liquid mixture, which comprises the solvent, dissolved polyvinyl chloride and dissolved DINCH.

Preferably, at least 90 weight-%, more preferably at least 95 weight-%, more preferably at least 98 weight-%, of the polymer comprised in the polymeric material provided in (a) are polyvinyl chloride, based on the overall weight of the polymer comprised in the polymeric material being 100 weight-% and the polymeric material comprises the plasticizer, preferably at least DINCH, in an amount in the range of from 20 to 490 phr, wherein more preferably, at least 90 weight-%, more preferably at least 95 weight-%, more preferably at least 98 weight-% of the plasticizer comprised in the polymeric material provided in (a) are DINCH, the total amount of the plasticizer comprised in the polymeric material being 100 weight-%.

In addition to plasticizer(s), the polymeric material may comprise further additives, preferably an additive(s) selected from the group consisting of stabilizer, slip agent, filler, colorant (dye and/or optical brightener and/or pigment), flame inhibitor, light stabilizer, blowing agent, polymeric processing agent, impact modifier, antistatic, biostabilizer, or a mixture of two or more thereof. Stabilizers are the usual polyvinyl chloride stabilizers in solid and liquid form, preferably selected from the group consisting of Ca/Zn, Ba/Zn, Pb, Sn stabilizer, acid-binding layer silicate, carbonate (preferably hydrotalcite) and mixtures of two or more thereof. The polymeric material preferably contains a stabilizer content in the range of from 0.05 to 7 weight-% based on the total weight of the polymeric material being 100 weight-%. Preferably, the content of the stabilizer is in the range of from 0.1 to 5 weight-%, more preferably in the range of from 0.5 to 3 weight-%. Lubricants generally serve to reduce adhesion between the disclosed molding composition or the disclosed plastisol and surfaces and are intended, for example, to reduce frictional forces during mixing, plasticizing or molding. All common lubricants used in plastics processing can be used as lubricants in the polymeric material. Lubricants commonly used in plastics processing are, for example, hydrocarbons, such as oils, kerosenes, PE waxes or mixtures thereof, fatty alcohols containing 6 to 20 carbon atoms, ketones, carboxylic acids, such as fatty acids, montanic acids or mixtures thereof, oxidized PE waxes, metal salts of carboxylic acids, carboxylic acid amides, carboxylic acid esters resulting from the esterification of alcohols such as ethanol, fatty alcohols, glycerol, ethanediol or pentaerythritol with long-chain carboxylic acids. The polymeric material preferably contains a lubricant content in the range of from 0.01 to 10 weight-% based on the total weight of the polymeric material being 100 weight-%. Preferably, that the lubricant content is from 0.05 to 5 weight-%, more preferably in the range of from 0.2 to 2 weight-%. Fillers are generally used to positively influence the compressive, tensile and/or flexural strength, the rigidness and/or the heat distortion temperature of the polymeric material. For example, carbon black and/or inorganic fillers are preferably present as fillers in the disclosed polymeric material. Inorganic fillers are preferably selected from the group consisting of natural calcium carbonates, such as chalk, limestone, marbles, synthetic calcium carbonates, dolomite, silicates, silica, sand, diatomaceous earth, aluminosilicates, such as kaolin, mica, feldspar, and any mixture of two or more of the previously mentioned fillers. The polymeric material preferably contains a filler content in the range of from 0.01 to 80 weight-% based on the total weight of the molding compound or plastisol. Preferably, that the content in the range of from fillers is 0.01 to 60 weight-% more preferably 1 to 40 weight-%. Thus, the disclosed polymeric material preferably contains a filler content in the range of from 2, 5, 8, 10, 12, 15, 18, 20, 22, 25, 27, 30, 33, 36 or 39 weight-%. Colorants can be used to adapt the disclosed molding composition or the disclosed plastisol to different applications. Colorants may be, for example, pigments or dyes. Pigments may be, for example, inorganic and/or organic pigments contained in the polymeric material. Inorganic pigments may be cobalt pigments such as CoO/Al₂O₃ and/or chromium pigments such as Cr₂O₃. Organic pigments may be monoazo pigments, condensed azo pigments, azomethine pigments, anthraquinone pigments, quinacridones, phthalocyanine pigments and/or dioxazine pigments. The disclosed molding composition or the disclosed plastisol preferably contains a colorant content in the range of from 0.01 to 10 weight-%, based on the total weight of the polymeric material being 100 weight-%. Preferably, the content in the range of from colorants is 0.05 to 5 weight-% more preferably 0.1 to 3 weight-%. Flame inhibitors may serve to reduce the flammability of the disclosed molding compound or the disclosed plastisol and to reduce smoke formation during combustion. Flame inhibitors that are preferably present in the disclosed polymeric material are preferably selected from the group consisting of antimony trioxide, chlorinated kerosene, phosphate esters, aluminum hydroxide, boron compound and mixtures of two or more of these compounds. The polymeric material preferably contains a flame inhibitor content in the range of from 0.01 to 10 weight-% based on the total weight of the polymeric material being 100 weight-%. It is preferred that the flame inhibitor content is in the range of from 0.2 to 5 weight-% more preferably in the range of from 0.5 to 2 weight-%. Light stabilizers, such as UV absorbers, may serve to protect the disclosed molding composition or the disclosed plastisol from damage due to the influence of light. Light stabilizers are preferably selected from the group consisting of hydroxybenzophenone, hydroxyphenylbenzotriazole, cyanoacrylate, hindered amine light stabilizer such as derivatives of 2,2,6,6-tetramethylpiperidine, and mixtures of two or more of these compounds. The polymeric material preferably contains a light stabilizer content in the range of from 0.01 to 7 weight-% based on the total weight of the polymeric material being 100 weight-%. Preferably, the light stabilizer content is in the range of from 0.02 to 4 weight-% more preferably in the range of from 0.05 to 3 weight-%.

### Contacting

In some preferred embodiments of the method for removal of plasticizer from a polymeric material, contacting the polymeric material with the solvent comprising gamma-valerolactone in (b) is done at a temperature T1 below 190° C., preferably below 180° C., more preferably below 170° C., more preferably at a temperature T1 in the range of from 90 to <170° C., more preferably a temperature T1 in the range of from 95 to 165° C., more preferably a temperature T1 in the range of from 100 to 150° C.

In some preferred embodiments of the method for removal of plasticizer from a polymeric material, contacting the polymeric material with the solvent comprising gamma-valerolactone in (b) is done for a period of time of at least 0.1 h, preferably for a period of time in the range of from 0.1 to 10 h, preferably for a period of time in the range of from 0.1 to 6 h, more preferably for a period of time in the range of from 0.1 to 4 h. In some preferred embodiments of the method for removal of plasticizer from a polymeric material, contacting the polymeric material with the solvent comprising gamma-valerolactone in (b) is done at a pressure in the range of from 800 to 200,000 hPa. In some preferred embodiments of the method for removal of plasticizer from a polymeric material, contacting the polymeric material with the solvent comprising gamma-valerolactone in (b) is done with a in mass based ratio polymeric material: solvent in the range of 1:1 to 1:100 more preferably in the range of from 1:1 to 1:20, more preferably in the range of from 1:1 to 1:10.

“Contacting” preferably means that the polymer is at least partially immersed in the solvent. Preferably, the polymer is at least partially immersed in the solvent in that at least 60%, more preferably at least 70%, more preferably at least 80%, more preferably at least 90%, more preferably at least 95%, more preferably at least 99% of the polymer's surface are in contact with the solvent, based on the total surface of the polymer material being 100%.]

### Anti-Solvent

In some preferred embodiments of the method for removal of plasticizer from a polymeric material, step (c) comprises:
(c.1) adjusting the temperature to a temperature T2, which is below T1, preferably a temperature in the range of from 10° C. to 100° C., preferably a temperature in the range of from 15 to 90° C., more preferably in the range of from 20 to 80° C.;
(c.2) precipitating the polymer from the mixture obtained in (b) at T2 by addition of an antisolvent;
   thereby obtaining a solid residue, which comprises the polymer, and a liquid phase, which comprises the solvent, the anti-solvent and the dissolved plasticizer.

A solvent is defined according to ULLMANN'S Encyclopedia of Industrial Chemistry (Wiley-VCH Verlag Gmbh & Co. KGaA, Weinheim, 2012, Vol. 33, Chapter “Solvents”, pages 619 to 688, especially page 626; DOI: 10.1002/14356007.a24_437) as being able to dissolve a given substance such as a polymer (the solute) at room temperature; the solubility parameters of the solvent and the solute are similar. A non-solvent (aka anti-solvent) is defined as being unable to dissolve the substance in question. The solubility parameters and hydrogen bond parameters of an anti-solvent lie outside the solubility regions of the polymer(s) but inside the solubility regions of the substances to be dissolved, especially inside the solubility regions of the plasticizer(s).

In some preferred embodiments of the method for removal of plasticizer from a polymeric material, the anti-solvent used in step (c) or (c.2) is selected from the group consisting of water, C1 to C5 monoalcohol, C1 to C6 dialcohol and mixtures of two or more of these solvents, preferably from the group consisting of water, C1 to C5 monoalcohol, C1 to C5 dialcohol and mixtures of two or more of these solvents, more preferably from the group consisting of water, C1 to C3 monoalcohol and mixtures of two or more of these solvents, more preferably the anti-solvent used in step (c) or (c.2) comprises iso-propanol, more preferably at least 95 weight-% of the anti-solvent used in step (c) or (c.2) consist of iso-propanol. As GVL, the iso-propanol used is preferably a biorenewable solvent (biorenewable iso-propanol), i.e. is obtained from carbohydrate-based biomasses and is thus a “green” solvent. BioRenewable solvents are sourced from renewable, sustainable biobased materials, significantly lowering their environmental impact. BioRenewable solvents preferably are tested to comprise biobased carbon according to ASTM Standard D6866-16.

In some specific embodiments, the polymer comprised in the polymeric material provided in (a) comprises at least polyvinyl chloride (TP.30) and the plasticizer comprised in the polymeric material provided in (a) comprises at least DINCH, and further, the anti-solvent used in step (c) or (c.2) comprises at least iso-propanol. In these specific embodiments, the method for removal of plasticizer from a polymeric material comprises:
(a) providing a polymeric material, which comprises at least polyvinyl chloride (TP.30) as polymer and a plasticizer, which comprises at least DINCH, and providing a solvent comprising gamma-valerolactone;
(b) contacting the polymeric material with the solvent comprising gamma-valerolactone, thereby obtaining a liquid mixture, which comprises the solvent, dissolved polyvinyl chloride and dissolved DINCH; and
(c) precipitating at least the polyvinyl chloride from the mixture obtained in (b) by addition of an anti-solvent, which comprises iso-propanol; or (instead of (c) only)
(c.1) adjusting the temperature to a temperature T2, which is below T1, preferably a temperature in the range of from 10° C. to 100° C., preferably a temperature in the range of from 15 to 90° C., more preferably in the range of from 20 to 80° C.; and
(c.2) precipitating the polyvinyl chloride from the mixture obtained in (b) at T2 by addition of an anti-solvent, which comprises iso-propanol, preferably biorenewable iso-propanol;
   thereby obtaining a solid residue, which comprises the polyvinyl chloride and a liquid phase, which comprises the solvent, (biorenewable) iso-propanol and the dissolved DINCH.

In these specific embodiments, at least 90 weight-%, more preferably at least 95 weight-%, more preferably at least 98 weight-%, of the polymer comprised in the polymeric material provided in (a) are polyvinyl chloride, based on the overall weight of the polymer comprised in the polymeric material being 100 weight-% and the polymeric material comprises the plasticizer, preferably at least DINCH, in an amount in the range of from 20 to 490 phr, wherein more preferably, at least 90 weight-%, more preferably at least 95 weight-%, more preferably at least 98 weight-% of the plasticizer comprised in the polymeric material provided in (a) are DINCH, the total amount of the plasticizer comprised in the polymeric material being 100 weight-%, and preferably at least 95 weight-% of the anti-solvent used in step (c) or (c.2) consist of iso-propanol.

Preferably, the anti-solvent is added in step (c) or (c.2) in a weight-based ratio anti-solvent:polymeric material in the range of from 4:1 to 75:1, more preferably in the range of from 5:1 to 50:1, more preferably in the range of from 5:1 to 10:1. The weight of the polymeric material is the weight of the polymeric material comprising polymer and plasticizer initially provided in (a).

### Amount of Residual Plasticizer

In some preferred embodiments of the method for removal of plasticizer from a polymeric material, the polymer of the solid residue obtained in (c) or (c.2) comprises <5%, preferably <1%, of the amount of plasticizer, which had been present in the polymeric material provided in (a).

### Work-Up Steps

In some preferred embodiments of the method for removal of plasticizer from a polymeric material, the method further comprises:
(d) separating the solid residue, which comprises the polymer obtained in (c) or (c.2) from the liquid phase, which comprises the solvent, the anti-solvent and the dissolved plasticizer, thereby obtaining the solid residue, which comprises the polymer and the liquid phase, which comprises the solvent, the anti-solvent and the dissolved plasticizer;
(e) optionally washing the solid residue obtained in (d) with anti-solvent;
(f) drying the solid residue obtained in (d) or the washed solid residue obtained in (e).

The separation in (d) is done by methods and means known to the skilled person, especially solid-liquid separation methods such as filtration, for example, heated pressure filtration, sedimentation or centrifugation (see Handbuch der mechanischen Fest-Flüssig-Trennung Taschenbuch—29. April 2004 von Klaus Luckert (Herausgeber)).

In some preferred embodiments of the method for removal of plasticizer from a polymeric material, the method comprises one or more work-up step(s), wherein the one or more work-up step(s) preferably comprise
(g) separating solvent and anti-solvent by distillation and/or separating solvent from dissolved plasticizer by distillation, thereby obtaining a, preferably liquid fraction comprising the plasticizer and one or more liquid fraction(s) comprising the solvent and/or the anti-solvent.

The plasticizer obtained in (g) is preferably in liquid form. However, due to the higher molar masses and the resulting higher boiling temperatures of the plasticizer compared to solvent and anti-solvent, the plasticizer is not removed in distillation.

In some preferred embodiments of the method for removal of plasticizer from a polymeric material, the method further comprises recycling the separated solvent obtained in (g) at least partially to (b) and/or recycling the separated anti-solvent obtained on (g) at least partially to (c).

2^{nd} Aspect—Polymer Obtained or Obtainable from the Method

In a second aspect, the invention is related to a polymer obtained or obtainable from the method according to the first aspect, preferably from (e) and/or (f) according to the method of the first aspect. All details, embodiments and preferred embodiments described above in the section related to the first aspect apply also for the second aspect.

### 3^{rd} Aspect—Plasticizer Obtained or Obtainable Form the Method

In a third aspect, the invention is related to a plasticizer obtained or obtainable form the method according to the first aspect, preferably from (g). All details, embodiments and preferred embodiments described above in the section related to the first aspect apply also for the third aspect.

### 4^{th} Aspect—Use of the Polymer

According to a fourth aspect, the invention is directed to the use of the polymer obtained or obtainable from the method according to the first aspect, preferably from (e) and/or (f) according to the method of the first aspect for preparing a polymeric product, preferably a soft polymeric product comprising at least one plasticizer, wherein the at least one plasticizer is preferably REACH approved. All details, embodiments and preferred embodiments described above in the section related to the first aspect apply also for the fourth aspect.

A REACH approved plasticizer means a plasticizer, which is registered under the Regulation (EC) No 1907/2006 “Registration, Evaluation, Authorization and Restriction of Chemicals (REACH)” and is not listed in Annex 17 of the Regulation.

In some preferred embodiments, as indicated above, the polymer obtained or obtainable from the method according to the first aspect, preferably from (e) and/or (f) according to the method of the first aspect is used for preparation of a soft polymeric product.

In an aspect of said preferred embodiments, the invention is also directed to a method for preparing a product comprising
(I) providing a polymer as obtained from the method according to the first aspect, preferably from (e) and/or (f) according to the method of the first aspect;
(II) preparing a polymeric product, preferably a soft polymeric product by adding at least one plasticizer, from the polymer provided in (I), wherein the at least one plasticizer is preferably REACH approved.

In some alternative preferred embodiments, the polymer obtained or obtainable from the method according to the first aspect, preferably from (e) and/or (f) according to the method of the first aspect, is used for preparation of a rigid polymeric product without addition of plastizicer(s).

In an aspect of said alternative preferred embodiments, the invention is also directed to a method for preparing a rigid polymeric product comprising
(I) providing a polymer as obtained from the method according to the first aspect, preferably from (e) and/or (f) according to the method of the first aspect;
(II) preparing a rigid polymeric product from the polymer provided in (I), preferably by shaping,
   wherein neither in (I) nor in (II) plasticizer(s) are added.

“Without addition of plastizicer(s)” and “neither in (I) nor in (II) plasticizer(s) are added” means that, even if a certain amount of plasticizer(s) is present, said amount is too low to have an impact on the rigid properties of the rigid polymeric product.

The rigid polymeric product obtained, i.e. the rigid polymeric material made from the polymer obtained or obtainable from the method according to the first aspect, preferably from (e) and/or (f) according to the method of the first aspect, is used, for example, for the production of plates, tubes, pipes, profiles, blisters, records, windows, window profiles, traffic management, floor covering, or thermoformed sheets.

### 5^{th} Aspect—Use of the Plasticizer

According to a fifth aspect, the invention is directed to the use of the plasticizer obtained or obtainable from the method according to the first aspect, preferably from (g) according to the method of the first aspect, optionally after one or more work-up steps, for preparing a soft polymer. All details, embodiments and preferred embodiments described above in the section related to the first aspect apply also for the fifth aspect. The same applies for the REACH based definition given in the section above related to the fourth aspect of the invention.

In some preferred embodiments, the invention is also directed to a method for preparing a soft polymeric product comprising
(I) providing a plasticizer obtained or obtainable from the method according to the first aspect, preferably from (g) according to the method of the first aspect and a polymer;
(II) preparing a soft polymeric material from the polymer and the plasticizer provided in (I).

Preferably, the polymer provided in (I) is a (fresh or recycled) polymer as defined in the section related to the first aspect as TP.1 to TP.38.

The soft polymeric material obtained as described in the sections related to the 4^{th} and the 5^{th} aspect comprises the plasticizer in some embodiments distributed in the polymer or in alternative embodiments, the polymer, preferably in powdered form, is dispersed, optionally with pigments, fillers and additives, such as blowing agents, in a liquid plasticizer (plastisol). The plasticizer is not chemically bonded to the polymer but rather embedded in the polymer or the polymer is dispersed in the (liquid) plasticizer.

The soft polymeric material obtained, either the soft polymeric material made from the polymer obtained or obtainable from the method according to the first aspect, preferably from (e) and/or (f) according to the method of the first aspect or the soft polymeric material made from the plasticizer obtained or obtainable from the method according to the first aspect, preferably from (g) according to the method of the first aspect, is used, for example, for the production of molded bodies, gloves, films, wallpaper, or heterogeneous flooring, or for textile coating.

Molded articles are, for example, containers, apparatuses, or foamed devices. Containers are, for example, housings of electrical appliances, such as kitchen appliances or computer housings, pipes, hoses, such as water or irrigation hoses, industrial rubber hoses, chemical hoses, sheathing for wire or cable, sheathing for tools, bicycle, scooter, or wheelbarrow handles, metal coatings, or packaging containers. Apparatus are, for example, tools, furniture, such as chairs, shelves, tables, records, profiles, such as window profiles, floor profiles for outdoor use, or profiles for conveyor belts, components for vehicle construction, such as body components, underbody protection, or vibration dampers, or erasers. Foamed devices are, for example, cushions, mattresses, foams or insulation materials. Films are, for example, tarpaulins, such as truck tarpaulins, roof tarpaulins, geo membrane tarpaulins, stadium roofs or tent tarpaulins, gaskets, laminated films, such as films for laminated safety glass, self-adhesive films, laminating films, shrink films, outdoor floor coverings, adhesive tape films, coatings, swimming pond films, ornamental pond films, tablecloths or artificial leather. The molding compound are used to produce molded articles or films that come into direct contact with humans or food. Molded articles or films that come into direct contact with humans or food are, for example, medical products, hygiene products, food packaging, indoor products, baby and children's products, child care articles, sports or leisure products, clothing, fibers or fabrics. Medical products that are manufactured using the molding compound are, for example, enteral feeding or hemodialysis tubes, ventilation tubes, drainage tubes, infusion tubes, infusion bags, blood bags, catheters, tracheal tubes, disposable syringes, gloves, or respiratory masks. Food packaging products that are made using the molding compound are, for example, cling film, food tubing, drinking water tubing, food storage or freezing containers, lid seals, closure caps, crown caps, or artificial wine corks. Interior products that are manufactured using the molding compound are, for example, floor coverings, which are homogeneous or composed of multiple layers consisting of at least one foamed layer, such as floor coverings, mud flap mats, sports floors, Luxury Vinyl Tiles (LVT), artificial leather, wall coverings, foamed or non-foamed wallpaper in buildings, trim or console covers in vehicles. Baby and children's products that are manufactured using the molding compound are, for example, toys such as dolls, play figures or plasticine, inflatable toys such as balls or rings, stopper socks, swimming aids, stroller covers, changing pads, hot water bottles, teething rings or bottles. Sports or recreational products that are made using the molding compound are, for example, exercise balls, exercise mats, seat cushions, massage balls or rollers, shoes, shoe soles, balls, air mattresses, safety goggles, gloves, or water bottles. Clothing that are made using the molding compound are latex clothing, protective clothing, rain jackets or rubber boots, for example.

In preferred embodiments, where the soft polymeric material obtained is a plastisol, said plastisol is usually used as follows:

The plastisol is usually formed into the shape of the finished product by various processes, such as coating, casting, such as shell casting or rotational molding, dipping, printing, such as screen printing, spraying and the like. Subsequently, gelling is carried out by heating, and after cooling, a homogeneous, more or less flexible product is obtained. The plastisol are used for the production of films, wallpapers, seamless hollow bodies, gloves, heterogeneous flooring or for applications in the textile sector, such as textile coatings. Films are, for example, truck tarps, roof tarps, covers in general, such as boat covers, stroller covers or stadium roofs, tent tarps, geo membranes, tablecloths, coatings, swimming pond films, artificial leather or ornamental pond films. Gloves are, for example, gardening gloves, medical gloves, chemical gloves, protective gloves or disposable gloves. Furthermore, the plastisol are used to make, for example, gaskets, lid seals, trim or console covers in vehicles, dolls, play figures or plasticine, inflatable toys such as balls or rings, stopper socks, swimming aids, changing pads, exercise balls, exercise mats, seat cushions, vibrators, massage balls or rollers, latex clothing, protective clothing, rain jackets or rubber boots.

### 6^{th} Aspect—Further Processing of Plasticizer

According to a fifth aspect, the invention is directed to a process for further processing of a plasticizer, preferably the plasticizer obtained or obtainable from the method according to the first aspect, preferably from (g) according to the method of the first aspect, the process comprising one or more steps selected from the group consisting of hydrolysis, hydrogenation, and transesterification.

All details, embodiments and preferred embodiments described above in the section related to the first aspect or the fifth aspect apply also for the sixth aspect.

In some preferred embodiments of the process for further processing, hydrolysis comprises contacting the plasticizer with water and optionally contacting with a base or an acid and/or optionally under electromagnetic radiation, preferably light.

In some preferred embodiments of the process for further processing, hydrogenation comprises contacting the plasticizer with a hydrogen (H₂) containing gas under hydrogenation conditions, preferably hydrogenation conditions allowing for a core hydrogenation of an aromatic ring system, more preferably under conditions as disclosed in WO 99/032427 A1

Regarding the plasticizer, isosorbide ester is excluded regarding transesterification. In some preferred embodiments of the process for further processing, transesterification comprises contacting the plasticizer with an alcohol having a higher boiling point than the alcohol comprised in the alcoholic part of the plasticizer, optionally in the presence of an acidic or basic catalyst, wherein acidic catalyst preferably comprises a Broenstedt acid as well as a Lewis acid, and a basic catalyst preferably comprises, more preferably is NaHCO₃.

The present invention is further illustrated by the following embodiments and combinations of embodiments as indicated by the respective dependencies and back-references. In particular, it is noted that in each instance where a range of embodiments is mentioned, for example in the context of a term such as “The method of any of embodiments 1 to 4”, every embodiment in this range is meant to be explicitly disclosed for the skilled person, i.e. the wording of this term is to be understood by the skilled person as being synonymous to “The method of any of embodiments 1, 2, 3, and 4”.
1. A method for removal of plasticizer from a polymeric material comprising:
   (a) providing a polymeric material, which comprises a polymer and a plasticizer, and providing a solvent comprising gamma-valerolactone;
   (b) contacting the polymeric material with the solvent comprising gamma-valerolactone, thereby obtaining a liquid mixture, which comprises the solvent, dissolved polymer and dissolved plasticizer.
2. The method of embodiment 1, further comprising:
   (c) precipitating the polymer from the mixture obtained in (b) by addition of an antisolvent, thereby obtaining a solid residue, which comprises the polymer, and a liquid phase, which comprises the solvent, the anti-solvent and the dissolved plasticizer.
3. The method of embodiment 1 or 2, wherein the polymer is preferably a thermoplastic polymer, more preferably a thermoplastic polymer selected from the group consisting of copolymer, which comprises in polymerized form at least two different monomers, the at least two monomers being selected from the group consisting of C₂ to C₁₀ mono olefin (preferably selected from the group consisting of ethylene, propylene, 1,3-butadiene, 2-chloro-1,3-butadiene and mixtures of two or more of these olefins), vinylalcohol, C₂ to C₁₀-alkylester of vinylalcohol, vinylacetate, vinylchloride, vinylidene chlorid, vinylidene fluorid, tetrafluoroethylene, glycidyl acrylate, glycidyl methacrylate, acrylate with alcohol component of branched or unbranched C1 to C10 alcohol methacrylate with alcohol components of branched or unbranched C1 to C10 alcohol, vinyl aromatic (preferably styrene), (meth)acrylonitrile, ethylenically unsaturated mono- or dicarboxylic acid, and maleic anhydride (TP.1); polyvinyl ester (TP.2); polycarbonate (TP.3); polyether (TP.4); polyether ketone (TP.5); thermoplastic polyurethane (TP.6); polysulfide (TP.7); polysulfone (TP.8); polyester (TP.9); polyalkylene terephthalate (TP.10); polyhydroxyalkanoate (TP.11); polybutylene succinate (TP.12); polybutylene succinate adipate (TP.13); polyacrylate with the same or different alcohol residues from the group of C₄ to C₈ alcohols, preferably selected from butanol, hexanol, octanol, and 2-ethylhexanol (TP.14); polymethyl methacrylate (TP.15); methyl methacrylate-butyl acrylate copolymer (TP.16); acrylonitrile-butadiene-styrene copolymer (TP.17); ethylene-propylene copolymer (TP.18); ethylene-propylene-diene copolymer (TP.19); polystyrene (TP.20); styrene-acrylonitrile copolymer (TP.21); acrylonitrile-styrene acrylate (TP.22); styrene-butadiene-methyl methacrylate copolymer (TP.23); styrene-maleic anhydride copolymer (TP.24); styrene-methacrylic acid copolymer (TP.25); polyoxymethylene (TP.26); polyvinyl alcohol (TP.27); polyvinyl acetate (TP.28); polyvinyl butyral (TP.29); polyvinyl chloride (TP.30); polycaprolactone (TP.31); polyhydroxybutyric acid (TP.32); polyhydroxyvaleric acid (TP.33); polylactic acid (TP.34); ethyl cellulose (TP.35); cellulose acetate (TP.36); cellulose propionate (TP.37); and cellulose acetate/butyrate (TP.38) and blends of two or more of these polymers.
4. The method of any one of embodiments 1 to 3, wherein the polymer is selected from the group consisting of copolymer comprising in polymerized form vinylchloride and at least one further monomer selected from the group indicated in embodiment 3 for TP.1; polyvinyl acetate (TP.28); polyvinyl butyral (TP.29); polyvinyl chloride (TP.30); polycaprolactone (TP.31); and blends of two or more of these polymers.
5. The method of any one of embodiments 1 to 4, wherein the polymer comprises polyvinyl chloride (TP.30), wherein preferably at least 90 weight-%, more preferably at least 95 weight-%, more preferably at least 98 weight-%, of the polymer comprised in the polymeric material are polyvinyl chloride, based on the overall weight of the polymer comprised in the polymeric material being 100 weight-%.
6. The method of any one of embodiments 1 to 5, wherein at least 20 weight-% of the polymeric material consists of the polymer, more preferably in the range of from 20 to 90 weight-% of the polymeric material consist of the polymer, the overall weight of the polymeric material being 100 weight-%.
7. The method of any one of embodiments 1 to 6, wherein the solvent comprising gamma-valerolactone comprises gamma-valerolactone and optionally one or more solvent(s) selected from the group consisting of water and organic solvents having a log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O—]ₙ—H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R¹R²N—C(═O)—R³, wherein R¹, R² are independently a C1 to C4 alkyl group and R³ is selected from the group consisting of C1 to C9 alkyl group, C1 to C10 ester group and C1 to C6 ether group, C3 to C6 lactame, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).
8. The method of any one of embodiments 1 to 7, wherein the plasticizer is selected from the group consisting of
   cyclohexane-1,2-dicarboxylic acid dialkylester, wherein the alkyl groups are independently selected from C4-C13 alkyl;
   cyclohexane-1,3-dicarboxylic acid dialkylester, wherein the alkyl groups are independently selected from C4-C13 alkyl;
   cyclohexane-1,4-dicarboxylic acid dialkylester, wherein the alkyl groups are independently selected from C4-C13 alkyl;
   phthalic acid dialkylester wherein the alkyl groups are independently selected from C4-C13 alkyl;
   phthalic acid alkylarylester wherein the alkyl group is selected from C4-C13 alkyl and the aryl group is selected from benzyl and phenyl;
   terephthalic acid dialkylester wherein the alkyl groups are independently selected from C4-C13 alkyl;
   trimellitic acid trialkylester;
   benzoic acid alkylester;
   dibenzoic acid esters of glycols;
   pentaerythritol esters;
   saturated monocarboxylic acid alkylester;
   unsaturated monocarboxylic acid ester;
   saturated dicarboxylic acid diester;
   unsaturated dicarboxylic acid diester;
   aromatic sulfonic acid ester;
   alkylsulfonic acid ester;
   glycerol ester;
   isosorbide ester;
   phosphoric acid ester;
   citric acid triester;
   acetylated citric acid triester;
   alkylpyrrolidone derivative;
   2,5-furane dicarboxylic acid dialkylester;
   2,5-tetrahydrofurane dicarboxylic acid dialkylester;
   polyester of aliphatic and/or aromatic polycarboxylic acid with at least dialcohol(s);
   epoxidized plant oil;
   epoxidized fatty acid mono alkyl ester;
and mixture of two or more thereof.
9. The method of any one of embodiments 1 to 8, wherein the plasticizer comprises at least a cyclohexane-1,2-dicarboxylic acid dialkylester of formula (I)

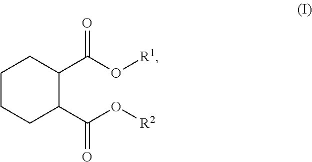

wherein R¹ and R² are independently selected from the group of branched C4 to C13 alkyl and straight C1 to C13 alkyl, preferably selected from the group consisting of branched C7 to C11 alkyl and straight C7 to C11 alkyl, more preferably R¹ and R² are independently from each other a branched or straight C9 alkyl residue, more preferably the plasticizer comprises at least 1,2-cyclohexane dicarboxylic acid diisononyl ester (DINCH).
10. The method of any one of embodiments 1 to 9, wherein the polymeric material comprises the plasticizer in an amount in the range of from 20 to 490 phr.
11. The method of any one of embodiments 1 to 10, wherein contacting the polymeric material with the solvent comprising gamma-valerolactone in (b) is done at a temperature T1 below 190° C., preferably below 180° C., more preferably below 170° C., more preferably at a temperature T1 in the range of from 90 to <170° C., more preferably a temperature T1 in the range of from 95 to 165° C., more preferably a temperature T1 in the range of from 100 to 150° C.
12. The method of any one of embodiments 1 to 11, wherein contacting the polymeric material with the solvent comprising gamma-valerolactone in (b) is done for a period of time of at least 0.1 h, preferably for a period of time in the range of from 0.1 to 10 h, preferably for a period of time in the range of from 0.1 to 6 h, more preferably for a period of time in the range of from 0.1 to 4 h.
13. The method of any one of embodiments 1 to 12, wherein contacting the polymeric material with the solvent comprising gamma-valerolactone in (b) is done at a pressure in the range of from 800 to 200,000 hPa.
14. The method of any one of embodiments 1 to 13, wherein contacting the polymeric material with the solvent comprising gamma-valerolactone in (b) is done with a in mass based ratio polymeric material: solvent in the range of 1:1 to 1:100 more preferably in the range of from 1:1 to 1:20, more preferably in the range of from 1:1 to 1:10.
15. The method of any one of embodiments 2 to 14, wherein step (c) comprises:
   (c.1) adjusting the temperature to a temperature T2, which is below T1, preferably a temperature in the range of from 10° C. to 100° C., preferably a temperature in the range of from 15 to 90° C., more preferably in the range of from 20 to 80° C.;
   (c.2) precipitating the polymer from the mixture obtained in (b) at T2 by addition of an anti-solvent;
   thereby obtaining a solid residue, which comprises the polymer, and a liquid phase, which comprises the solvent, the anti-solvent and the dissolved plasticizer.
16. The method of any one of embodiments 2 to 15, wherein the anti-solvent used in step (c) or (c.2) is selected from the group consisting of water, C1 to C5 monoalcohol, C1 to C6 dialcohol and mixtures of two or more of these solvents, preferably from the group consisting of water, C1 to C5 monoalcohol, C1 to C5 dialcohol and mixtures of two or more of these solvents, more preferably from the group consisting of water, C1 to C3 monoalcohol and mixtures of two or more of these solvents, more preferably the antisolvent used in step (c) or (c.2) comprises iso-propanol, more preferably at least 95 weight-% of the anti-solvent used in step (c) or (c.2) consist of iso-propanol.
17. The method of any one of embodiments 2 to 16, wherein the anti-solvent is added in step (c) or (c.2) in a weight-based ratio anti-solvent: polymeric material in the range of from 4:1 to 75:1, preferably in the range of from 5:1 to 50:1, more preferably in the range of from 5:1 to 10:1.
18. The method of any one of embodiments 1 to 17, wherein the polymer of the solid residue obtained in (c) or (c.2) comprises <5%, preferably <1% of the amount of plasticizer, which had been present in the polymeric material provided in (a).
19. The method of any one of embodiments 1 to 18 further comprising:
   (d) separating the solid residue, which comprises the polymer obtained in (c) or (c.2) from the liquid phase, which comprises the solvent, the anti-solvent and the dissolved plasticizer, thereby obtaining the solid residue, which comprises the polymer and the liquid phase, which comprises the solvent, the anti-solvent and the dissolved plasticizer;
   (e) optionally washing the solid residue obtained in (d) with anti-solvent;
   (f) drying the solid residue obtained in (d) or the washed solid residue obtained in (e).
20. The method of any one of embodiments 1 to 19 comprising one or more work-up step(s), wherein the one or more work-up step(s) preferably comprise
   (g) separating solvent and anti-solvent by distillation and/or separating solvent from dissolved plasticizer by distillation, thereby obtaining a, preferably liquid fraction comprising the plasticizer and one or more liquid fraction(s) comprising the solvent and/or the anti-solvent.
21. The method of embodiment 20, further comprising recycling the separated solvent obtained in (g) at least partially to (b) and/or recycling the separated anti-solvent obtained on (g) at least partially to (c).
22. A polymer obtained or obtainable from the method according to any one of embodiments 1 to 21, preferably from (e) and/or (f) and/or the polymer according to embodiment 18.
23. A plasticizer obtained or obtainable from the method according to any one of embodiments 1 to 21, preferably from (g).
24. Use of the polymer obtained or obtainable from the method according to any one of embodiments 1 to 21, preferably from (e) and/or (f) and/or the polymer according to embodiment 22 for, preparing a polymeric product, preferably a soft polymeric product comprising at least one plasticizer, wherein the at least one plasticizer is preferably REACH approved.
25. Use of the plasticizer obtained or obtainable from the method according to any one of embodiments 1 to 21, preferably from (g) and/or the plasticizer according to embodiment 23, optionally after one or more work-up steps, for preparing a soft polymer.
26. A method for preparing a product comprising
   (I) providing a polymer of embodiment 22;
   (II) preparing a polymeric product, preferably a soft polymeric product by adding at least one plasticizer, from the polymer provided in (I), wherein the at least one plasticizer is preferably REACH approved.
27. A method for preparing a soft polymeric product comprising
   (I) providing a plasticizer of embodiment 23 and a polymer;
   (II) preparing a soft polymeric material from the polymer and the plasticizer provided in (I).
28. The method of embodiment 27, wherein the polymer provided in (I) is a polymer as defined in any one of embodiments 3 to 5.
29. A process for further processing a plasticizer, preferably the plasticizer of embodiment 23, more preferably the plasticizer obtained or obtainable from the method according to any one of embodiments 1 to 21, preferably from (g), the process comprising one or more work-up steps selected from the group consisting of hydrolysis, hydrogenation, and transesterification.
30. The process for further processing of embodiment 29, wherein hydrolysis comprises contacting the plasticizer with water and optionally contacting with a base or an acid and/or optionally under electromagnetic radiation, preferably light.
31. The process for further processing of embodiment 29, wherein hydrogenation comprises contacting the plasticizer with a hydrogen (H2) containing gas under hydrogenation conditions, preferably hydrogenation conditions allowing for a core hydrogenation of an aromatic ring system.
32. The process for further processing of embodiment 29, wherein transesterification comprises contacting the plasticizer with an alcohol having a higher boiling point than the alcohol comprised in the alcoholic part of the plasticizer, optionally in the presence of an acidic or basic catalyst.

The present invention is further illustrated by the following reference examples, comparative examples, and examples.

### EXAMPLES

### Methods

### Hazen Color Index:

The Hazen color index (APHA color number) was determined according to DIN EN ISO 6271:2016-05 (Pt/Co, APHA, ASTM D1209, D5386).

### GPC:

### Sample Preparation

Approximately 20 mg sample was dissolved in 10 ml eluent (THF) over night. All sample solutions were filtered by a Macherey-Nagel PTFE (0.2 μm) filtered prior to injection. Sealed sample vials were placed into the auto sampler.

### Experimental Conditions

An Agilent 1200 HPLC system, consisting of a isocratic pump, vacuum degasser, auto sampler and a column oven (35° C.) was used. As detectors a Differential Refractive Index (DRI) and a variable Ultra Violet (UVW) Detector was used. Data acquisition and data processing of conventionally SEC data were done by WinGPC Unichrom, build 9666, of PSS (Polymer Standard Services). A combination of a Plgel 10μ Guard (7.5×50 mm) column and 3 PLgel MIXED-B columns (7.5×300 mm, 10μ) of Agilent were put in series. As an eluent, THF was used as a flow rate of 1 mL/min. Of each sample solution 100 μL was injected. The calibration was obtained by narrow molar mass distributed Polystyrene standards (Polymer Standard Services) having a molar mass range of M=580 till M=6.870.000 g/mol. Molar masses outside this range were extrapolated. The lowest possible integration limit was set at 25 ml (M(1800) ca.). No lower molar masses could be obtained due to possible polymer additives or solvent impurities.

### GC Area %:

The sample was analyzed by gas chromatography (GC), wherein the method detected individual components from a sample dependent on their individual retention times. The concentration of the individual component in the sample were given in its percental peak area as GC-area %.

### Chemicals

| | |
|---|---|
| (Chemical) name | Abbreviation |

Polymeric materials

| | |
|---|---|
| Polyvinylchloride | PVC |

Solvents, anti-solvents

| | |
|---|---|
| gamma-valerolactone (5-methyl oxolan-2-one) | GVL |
| iso-propanol | iPrOH |
| dimethoxymethane | methylal |

plasticizer

| | |
|---|---|
| 1,2-cyclohexanedicarboxylic acid diisononyl ester | Hexamoll ® DINCH |

### Reference Example 1: General Procedure for Extraction of Plasticizer from Soft PVC

Soft PVC samples were cut/shredded into pieces and placed in a reaction vessel (e.g. flask, tube, reaction vessel). GVL was added (in mass-based ratio polymeric material: GVL in the range of from 1:1 to 1:100, preferably in the range of from 1:1 to 1:10) and the mixture was heated by use of a suitable heating system (e.g. oil bath, heating blocks, mini-plant vessels) to a temperature in the range of from 100 to 150° C. After 0.1 to 4 h, the mixture was cooled to 80° C., 60° C. or room temperature and iPrOH was added at the given temperature to precipitate PVC. The mixture was filtered at room temperature, whereby a liquid phase comprising iPrOH and GVL enriched in plasticizer, and a solid residue containing PVC were obtained. The PVC residue was washed with a small amount of iPrOH. The thus obtained PVC residue was dried (for example in a vacuum compartment dryer).

### Example 1: Removal of Plasticizer from Soft PVC

Samples of soft PVC were treated as described in Reference Example 1. The samples all contained a known amount of the same plasticizer Hexamoll DINCH (60 phr, i.e. 36.9 weight-% based on the total weight of the soft PVC sample comprising PVC and the plasticizer being 100 weight-%). After treatment, the liquid phase comprising iPrOH and GVL enriched in plasticizer, was analyzed by GC. The PVC residue was further extracted by a conventional extraction method (using methylal) to determine the residual amount of plasticizer. The treatment conditions for the GVL extraction and the residual amounts of Hexamoll DINCH in the PVC after GVL extraction, i.e. the amounts extracted in the subsequent step by using methylal, are indicated in Table 1 below.

TABLE 1
Experimental results of examples 1-7

| | | | | | | Addition | Residual amount of | Amount of |
|---|---|---|---|---|---|---|---|---|
| | | | Mass | Amount | Amount | temperature | Hexamoll DINCH | Hexamoll DINCH |
| Example | Time | Temperature | based ratio | of PVC | of iPrOH | of iProH | in soft PVC after GVL | removed by GVL |
| no. | [h] | [° C.] | PVC:GVL | [g] | [ml] | [° C.] | extraction [%] | extraction [%] |
| 1 | 2 | 120 | 1:8 | 10 | 80 | 60 | 3.85 | 96.15 |
| 2 | 2 | 150 | 1:8 | 10 | 80 | 60 | 4.27 | 95.73 |
| 3 | 2 | 120 | 1:8 | 10 | 120 | 60 | 2.73 | 97.27 |
| 4 | 2 | 120 | 1:10 | 10 | 120 | 60 | 0.58 | 99.42 |
| 5 | 2 | 120 | 1:10 | 10 | 120 | 23 | 1.35 | 98.65 |
| 6 | 2 | 120 | 1:10 | 10 | 80 | 60 | 1.57 | 98.43 |
| 7 | 4 | 120 | 1:10 | 10 | 120 | 60 | 0.82 | 99.18 |

Molecular weights and dispersity of the polymer before and after treatment are listed in Table 2 below:

TABLE 2
Molecular weights and dispersity

GPC

| | Number average | Mass average | |
|---|---|---|---|
| | molecular weight | molecular weight | Dispersity |
| Material | Mn [g/mol] | Mw [g/mol] | Mw/Mn |
| Before | 69 900 | 173 000 | 2.5 |
| treatment | | | |
| After | 78 400 | 173 000 | 2.2 |
| treatment | | | |

### Recycling of Solvent GVL and Obtaining the Plasticizer

For recycling of the used solvent, first iPrOH was distilled off and then GVL. For the distillation of GVL following parameters were applied: temperature in the range of from 50 to 200° C., pressure in the range of from 2 hPa to ambient pressure (1013 hPa). Preferably, a temperature in the range of from 70 to 110° C., and a pressure in the range of from 5 to 30 hPa were applied. After evaporation of the solvent, the remaining liquid was Hexamoll DINCH.

The obtained GVL had a purity according to GC of >99%. For GLV, the Hazen color index was determined after distillation as 15. For iso-propanol, the Hazen color index was determined after distillation as zero.

### Comparative Example 1: Removal of Plasticizer from Soft PVC Using Different Solvents

Soft PVC samples were cut/shredded into pieces and placed in a reaction vessel (e.g. flask, tube, reaction vessel). iPrOH was added, and the mixture was stirred for two (2) hours under reflux (about 82° C.), wherein it was seen upon visual inspection that the PVC did not dissolve-contrary to Reference Example 1/Examples 1-7, no iPrOH was added to precipitate PVC. The mixture was cooled to room temperature and then filtered, whereby a liquid phase comprising the respective solvent enriched in plasticizer, and a solid residue containing PVC were obtained. The PVC residue was washed with a small amount of iPrOH. The thus obtained PVC was dried (for example in a vacuum compartment dryer).

The thus obtained dry PVC residue was further extracted by a conventional extraction method—the same as in Example 1 (using methylal)—to determine the residual amount of plasticizer. The treatment conditions for the solvent extraction and the residual amounts of Hexamoll DINCH in the PVC after solvent extraction, i.e. the amounts extracted in the subsequent step by using methylal, are indicated in Table 3 below.

### Comparative Examples 2 and 3: Removal of Plasticizer from Soft PVC Using Different Solvents with Prolonged Extraction

Soft PVC samples were cut/shredded into pieces and placed in a reaction vessel (e.g. flask, tube, reaction vessel). The respective solvent was added, and the mixture was stirred for four (4) hours under reflux at ambient pressure in the range of from 1000 to 1050 hPa, wherein it was seen upon visual inspection for MeOH as well as for the mixture MeOH+methyl propanoate, that the PVC did not dissolve—contrary to Reference Example 1/Examples 1-7, no iPrOH was added to precipitate PVC. The mixture was cooled to room temperature and then filtered, whereby a liquid phase comprising the respective solvent enriched in plasticizer, and a solid residue containing PVC were obtained. The thus obtained PVC was dried (for example in a vacuum compartment dryer).

The thus obtained dry PVC residue was further extracted by a conventional extraction method—the same as in Example 1 (using methylal)—to determine the residual amount of plasticizer. The treatment conditions for the solvent extraction and the residual amounts of Hexamoll DINCH in the PVC after solvent extraction, i.e. the amounts extracted in the subsequent step by using methylal, are indicated in Table 3 below.

TABLE 3
Experimental conditions and results of Comparative Examples 1, 2 and 3

| | | | | | Amount of | | Residual amount of | Amount of |
|---|---|---|---|---|---|---|---|---|
| | | | | Mass | starting | Amount of | Hexamoll DINCH | Hexamoll DINCH |
| Comparative | | Time | Temperature | based ratio | material | solvent | in PVC after | removed by |
| Example | Solvent | [h] | [° C.] | PVC:solvent | [g] | [g] | extraction [%] | extraction [%] |
| 1 | iPrOH | 2 | reflux | 1:7.8 | 10 | 78 | 18.4 | 81.6 |
| 2 | MeOH | 4 | reflux | 1:1.5 | 30 | 45 | 47.5 | 52.5 |
| 3 | MeOH + | 4 | reflux | 1:2.49 | 30 | MeOH: 45 | 79.1 | 20.9 |
| | Methyl | | | | | Methyl | | |
| | propanoate | | | | | propanoate: 29.7 | | |

### Results

As can be seen when considering Examples 1-7 and Comparative Examples 1-3, using GVL for plasticizer extraction enabled a significantly higher removal of the plasticizer from the soft PVC as when iPrOH, MeOH or the mixture of MeOH+methyl propanoate was used—more than 95% of the plasticizer were removed when using GVL whereas different solvents gave at best 81.6%.

### CITED LITERATURE

WO 01/70865 A1
WO 02/14413 A1
U.S. Pat. No. 4,071,479 A
Becker/Braun, Kunststoff-Handbuch, Band 2/1: Polyvinylchlorid”, 2nd edition, Carl Hanser Verlag, Munich ULLMANN'S Encyclopedia of Industrial Chemistry (Wiley-VCH Verlag Gmbh & Co. KGaA, Weinheim, 2012, Vol. 33, Chapter “Solvents”, pages 619 to 688; DOI: 10.1002/14356007.a24_43
Handbuch der mechanischen Fest-Flüssig-Trennung Taschenbuch—29. April 2004 von Klaus Luckert (Herausgeber)

1.-15. (canceled)

16. A method for removal of plasticizer from a polymeric material comprising:
(a) providing a polymeric material, which comprises a polymer and a plasticizer, and providing a solvent comprising gamma-valerolactone; and
(b) contacting the polymeric material with the solvent comprising gamma-valerolactone, thereby obtaining a liquid mixture, which comprises the solvent, dissolved polymer and dissolved plasticizer.

17. The method of claim 16, further comprising:
(c) precipitating the polymer from the mixture obtained in (b) by addition of an antisolvent, thereby obtaining a solid residue, which comprises the polymer, and a liquid phase, which comprises the solvent, the anti-solvent and the dissolved plasticizer.

18. The method of claim 16, wherein the polymer is a thermoplastic polymer.

19. The method of claim 18, wherein the thermoplastic polymer is selected from the group consisting of copolymer, which comprises in polymerized form at least two different monomers, the at least two monomers being selected from the group consisting of C₂ to C₁₀ mono olefin, vinylalcohol, C₂ to C₁₀-alkylester of vinylalcohol, vinylacetate, vinylchloride, vinylidene chlorid, vinylidene fluorid, tetrafluoroethylene, glycidyl acrylate, glycidyl methacrylate, acrylate with alcohol component of branched or unbranched C1 to C10 alcohol methacrylate with alcohol components of branched or unbranched C1 to C10 alcohol, vinyl aromatic, (meth)acrylonitrile, ethylenically unsaturated mono- or dicarboxylic acid, and maleic anhydride (TP.1); polyvinyl ester (TP.2); polycarbonate (TP.3); polyether (TP.4); polyether ketone (TP.5); thermoplastic polyurethane (TP.6); polysulfide (TP.7); polysulfone (TP.8); polyester (TP.9); polyalkylene terephthalate (TP.10); polyhydroxyalkanoate (TP.11); polybutylene succinate (TP.12); polybutylene succinate adipate (TP.13); polyacrylate with the same or different alcohol residues from the group of C4 to C8 alcohols; polymethyl methacrylate (TP.15); methyl methacrylate-butyl acrylate copolymer (TP.16); acrylonitrile-butadiene-styrene copolymer (TP.17); ethylene-propylene copolymer (TP.18); ethylenepropylene-diene copolymer (TP.19); polystyrene (TP.20); styrene-acrylonitrile copolymer (TP.21); acrylonitrile-styrene acrylate (TP.22); styrene-butadiene-methyl methacrylate copolymer (TP.23); styrene-maleic anhydride copolymer (TP.24); styrene-methacrylic acid copolymer (TP.25); polyoxymethylene (TP.26); polyvinyl alcohol (TP.27); polyvinyl acetate (TP.28); polyvinyl butyral (TP.29); polyvinyl chloride (TP.30); polycaprolactone (TP.31); polyhydroxybutyric acid (TP.32); polyhydroxyvaleric acid (TP.33); polylactic acid (TP.34); ethyl cellulose (TP.35); cellulose acetate (TP.36); cellulose propionate (TP.37); and cellulose acetate/butyrate (TP.38) and blends of two or more of these polymers.

20. The method of claim 16, wherein the polymer is selected from the group consisting of a copolymer comprising in polymerized form vinylchloride and at least one further monomer selected from the group consisting of C₂ to C₁₀ mono olefin, vinylalcohol, C₂ to C₁₀-alkylester of vinylalcohol, vinylacetate, vinylchloride, vinylidene chlorid, vinylidene fluorid, tetrafluoroethylene, glycidyl acrylate, glycidyl methacrylate, acrylate with alcohol component of branched or unbranched C1 to C10 alcohol methacrylate with alcohol components of branched or unbranched C1 to C10 alcohol, vinyl aromatic, (meth)acrylonitrile, ethylenically unsaturated mono- or dicarboxylic acid, and maleic anhydride for TP.1; polyvinyl acetate (TP.28); polyvinyl butyral (TP.29); polyvinyl chloride (TP.30); polycaprolactone (TP.31); and blends of two or more of these polymers.

21. The method of claim 16, wherein the solvent comprising gamma-valerolactone comprises gamma-valerolactone and optionally one or more solvent(s) selected from the group consisting of water and organic solvents having a log K_{OW} in the range of from −1.6 to +1.6.

22. The method of claim 21, wherein the solvent is selected from the group consisting of water, C5 to C12 alkane, aliphatic C1 to C10 alcohol, C3 to C10 ketone, C2 to C10 cyclic ketone, HO—[C1 to C10 alkyl-O—]ₙ—H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, C3 to C6 lactame, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).

23. The method of claim 16, wherein the plasticizer is selected from the group consisting of
cyclohexane-1,2-dicarboxylic acid dialkylester, wherein the alkyl groups are independently selected from C4-C13 alkyl;
cyclohexane-1,3-dicarboxylic acid dialkylester, wherein the alkyl groups are independently selected from C4-C13 alkyl;
cyclohexane-1,4-dicarboxylic acid dialkylester, wherein the alkyl groups are independently selected from C4-C13 alkyl;
phthalic acid dialkylester wherein the alkyl groups are independently selected from C4-C13 alkyl;
phthalic acid alkylarylester wherein the alkyl group is selected from C4-C13 alkyl and the aryl group is selected from benzyl and phenyl;
terephthalic acid dialkylester wherein the alkyl groups are independently selected from C4-C13 alkyl;
trimellitic acid trialkylester;
benzoic acid alkylester;
dibenzoic acid esters of glycols;
pentaerythritol esters;
saturated monocarboxylic acid alkylester;
unsaturated monocarboxylic acid ester;
saturated dicarboxylic acid diester;
unsaturated dicarboxylic acid diester;
aromatic sulfonic acid ester;
alkylsulfonic acid ester;
glycerol ester;
isosorbide ester;
phosphoric acid ester;
citric acid triester;
acetylated citric acid triester;
alkylpyrrolidone derivative;
2,5-furane dicarboxylic acid dialkylester;
2,5-tetrahydrofurane dicarboxylic acid dialkylester;
polyester of aliphatic and/or aromatic polycarboxylic acid with at least dialcohol(s);
epoxidized plant oil;
epoxidized fatty acid mono alkyl ester;
and mixture of two or more thereof.

24. The method of claim 16, wherein contacting the polymeric material with the solvent comprising gamma-valerolactone in (b) is done at a temperature T1 below 190° C.; or wherein contacting the polymeric material with the solvent comprising gamma-valerolactone in (b) is done for a period of time of at least 0.1 h; or wherein contacting the polymeric material with the solvent comprising gamma-valerolactone in (b) is done at a pressure in the range of from 800 to 200,000 hPa.

25. The method of claim 17, wherein step (c) comprises:
(c.1) adjusting the temperature to a temperature T2, which is below T1;
(c.2) precipitating the polymer from the mixture obtained in (b) at T2 by addition of an antisolvent;
thereby obtaining a solid residue, which comprises the polymer, and a liquid phase, which comprises the solvent, the anti-solvent and the dissolved plasticizer.

26. The method of claim 25, wherein the temperature is in the range of from 10° C. to 100° C.

27. The method of claim 17, wherein the anti-solvent used in step (c) or (c.2) is selected from the group consisting of water, C1 to C5 monoalcohol, C1 to C6 dialcohol and mixtures of two or more of these solvents.

28. The method of claim 16 further comprising:
(d) separating the solid residue, which comprises the polymer obtained in (c) or (c.2) from the liquid phase, which comprises the solvent, the anti-solvent and the dissolved plasticizer, thereby obtaining the solid residue, which comprises the polymer and the liquid phase, which comprises the solvent, the anti-solvent and the dissolved plasticizer;
(e) optionally washing the solid residue obtained in (d) with anti-solvent; and
(f) drying the solid residue obtained in (d) or the washed solid residue obtained in (e).

29. The method of claim 28, further comprising one or more work-up step(s), wherein the one or more work-up step(s) comprise
(g) separating solvent and anti-solvent by distillation or separating solvent from dissolved plasticizer by distillation, thereby obtaining a liquid fraction comprising the plasticizer and one or more liquid fraction(s) comprising the solvent or the anti-solvent.

30. A polymer obtained from the method according to claim 16.

31. A plasticizer obtained from the method according to claim 16.

32. A polymeric product obtained from the method according to claim 16.

33. The polymeric product according to claim 32, wherein the polymeric product is a soft polymeric product comprising at least one plasticizer.

34. A soft polymer comprising a plasticizer obtained from the method according to claim 16, optionally after one or more work-up steps.

35. A process for further processing of a plasticizer according to claim 31, the process comprising one or more steps selected from the group consisting of hydrolysis, hydrogenation, and transesterification.
